(19) United States
(12) Patent Application Publication
(10) Pub. No.: US 2002/0016174 A1
(43) Pub. Date: Feb. 7, 2002

(54) Use of telephone numbers as domain names and as applied in portable electronic devices

(76) Inventors: Eric J. Gibson, Portland, OR (US); James Bedal, Boise, ID (US)

Correspondence Address: KEITH A. CUSHING, Registered Patent Attorney, 4201 S.W. VACUNA STREET, PORTLAND, OR, 97219, US

(21) Appl. No.: 09/847,075

(22) Filed: May 1, 2001

Related U.S. Application Data
(60) Provisional application No. 60/201,719, filed on May 3, 2000.
(60) Provisional application No. 60/214,720, filed on Jun. 29, 2000.

(51) Int. Cl. H04Q 7/20

(52) U.S. Cl. 455/464; 455/462

(57) ABSTRACT

A communication device includes a common database shared between Internet communication and voice communication subsystems whereby a user selects a given entry in the directory and further makes selection of communication between Internet and voice communication channels. A base address designator for each directory entry corresponds to a telephone number and to a registered domain name for an entity associated with that directory entry.

### REFERENCE TO RELATED PROVISIONAL APPLICATIONS

The present application relies on the following prior provisional applications filed by applicants herein: 1) Provisional Application No. 60/201,719 entitled A PROCESS OF PROVIDING INTERNET CONTENT BY USING TELEPHONE NUMBERS AS DOMAIN NAMES filed by applicants herein May 3, 2000; and 2) Provisional Application No. 60/214,720 entitled MODIFICATIONS TO COMMUNICATIONS ENABLED PORTABLE ELECTRONIC DEVICES THAT ENABLE THE DEVICES TO UTILIZE PHONE NUMBERS TO ACCESS WEB RESOURCES OR SEND EMAIL filed by applicants herein Jun. 25, 2000.

### BACKGROUND OF THE INVENTION

The present invention relates generally to communication systems and devices operating on such systems, and particularly to global telephone and computer communication systems and devices operating thereon.

The ubiquity and usefulness of the Public Switched Telephone Network (PSTN) is well established. Through decades of development and refinement, the PSTN provides a generally interconnected and interoperating global communication system. Key to the PSTN system is a line numbering system allowing, for example, a user in Boise, Id. to dial a number string and communicate with a neighborhood bar in Beijing, China. This line numbering system, specified as E.164, is an International Telecommunications Union (ITU) standard describing the familiar format of telephone numbers used throughout the world.

As wireless telephones developed, it was logical and sensible to incorporate wireless telephones into this existing, well-standardized, and familiar numbering framework.

Computer communications standards, however, developed separately from the PSTN framework. The high cost, and relatively limited capacities and capabilities of early computers, created a desire to link computers to share computing and data resources. Inter-computer communication drove an evolution of communication protocols and devices to facilitate computer-to-computer interaction and resource sharing. As the network of interconnected computers grew in number, there was a need for a uniform computer or node identification scheme. This ultimately resulted in what is now known as Internet Protocol (IP) addressing. An example of an IP address is “25.123.44.167.” An IP address comprises a sequence numeric values designating routing to a network resource.

The resulting global communications computer network, now commonly known as the Internet, makes use of IP addressing, but allows device or node addressing by universal resource locator (URL) entered by the user as a text string. Each resource is associated with a “domain name.” From the user-perspective, a domain name provides an intuitive and meaningful text string associated with the resource. Typically, domain names correspond to a commercial enterprise name or correspond to the resource content available. The actual network address for a given resource, however, is always an IP address.

People use text-based domain names because domain names have meaning to people. Computer networks use numeric-based IP addresses because IP addresses have meaning to computers and support efficient routing and addressing information between nodes on the computer network. At some point, computer programming automatically translates a user-generated and text-based domain name into a numeric-based IP address to support interaction on the Internet. Domain names are “registered” by associating a unique text-based domain name with a given and unique IP address. Unfortunately, a master list of registered domain names and associated IP addresses is too big to store on every computer, especially on typical Internet user computers.

When a user enters a domain name, for example when using a network browser program, the domain name must be translated into the associated IP address. The function of a Domain Name System (DNS) server is to translate a registered text-based domain name into the associated IP address. User's must configure their computers to hold an IP address for a primary DNS server and a secondary DNS server. In other words, the user knows and enters the specific numeric IP address sequences required to address a primary DNS server and, as a backup, a secondary DNS server. This allows the user's computer to access a DNS server for translation of a given text-based domain name into the associated IP address.

To function well as a system, each address must conform to certain standards and must be unique within the network. This calls for a centrally organized database for associating the text-based domain name for a network machine and its corresponding IP address. For a time, this name-to-address mapping system was a single file known as the Host Table. New hosts and their respective addresses joined the Host Table several times per week. While administrators of domain name servers could replicate the Host Table, the constantly changing Host Table required constant updates and replication to maintain a current and accurate association between registered domain names and existing IP addresses. This was an ongoing and enormous task which grew ever-more onerous as the Internet grew in size. The weakness of this Host Table system was, therefore, information centralization as well as the incredible size of the ever-growing Host Table file.

The Domain Name System (DNS) resolved these Host Table issues. The DNS operates as a hierarchical and distributed database. Interlocking DNS servers maintain a tree structure storing domain names and the associated IP addresses. Thus, DNS servers take an intuitive text-based domain dame and return the corresponding IP address. An example of a domain name is “naturalnetbehavior.com.” Domain names may contain, or solely consist of, a numeric sequence unrelated to the actual IP address. Alternatively, if a user knows the actual IP address of a desired Internet site, the IP address maybe input directly to the browser to bypass the domain name to IP address translation process. Also, DNS server databases can contain information beyond that which is required for the domain name-to-IP mapping.

Internet Corporation for Assigned Names and Numbers (ICANN) provides oversight of the Domain Name System (DNS). ICANN approves new top-level domains and sets standards for domain name registration. To function well, there must be a controlled distribution of domain names and IP addresses such that only one network resource is associated with a given domain name and IP address at any given time. One can imagine uncontrolled domain name deployment where, for example, several Johnson Plumbing companies use “johnsonplumbing.com.” The same would be true with IP addresses where hundreds might adopt “1.1.1.1” as their IP address. It is critical that domain names be registered and only one network resource be associated with any given domain name in any given top-level domain. IP addresses are likewise controlled.

The success of the Internet and the registration to date of approximately 30 million domain names, approximately ⅔ being in the “.com” top-level domain, has created an interesting challenge for users seeking an intuitive domain name. For example, one of the Johnson Plumbing Companies may opt for “jplumbing.com”, “johnsonsplumbing.com,” or “johnsonplumb.com,” etc. Very quickly, however, the desirably intuitive domain name becomes anything but intuitive. Because the Internet is a global network, incorrectly guessing at a domain name can return a resource link halfway around the globe. With the domain name System requiring that each resource have a unique domain name, those who have come late to the task of registering a domain name are left to select from limited and evermore non-intuitive domain names. ICANN has recognized this shortage and has authorized a new group of top-level domains. This solution is problematic, however, because the same domain name can be registered in multiple top-level domains, i.e., .com and .biz, thereby potentially creating more confusion.

A solution to this problem of domain name shortage is use IP addresses directly. This solution is functional, but far from intuitive. The difficultly of this solution, and one of the primary reasons for the creation of domain names, is the relatively complex and varied structure of IP addresses. For example, “1.1.1.1” and “111.111.111.111” are both IP address valid forms. It is also critical that the numbers be grouped correctly. The IP addresses “15.151.51.5” and the address “15.15.151.5” look very similar and have the same number sequence, but are completely different IP addresses. It would be difficult to gain general acceptance and support for direct use of IP addresses because users must be able to make intuitive and familiar use of node addressing.

Web-enabled wireless phones are mobile handsets used to make a telephone call or have an Internet session. The Internet and phone subsystems of these handsets typically share a power source, an antenna, user-input, display, transceiver, processing and memory subsystems. The operation of these devices, however, is model, i.e., operates in separate modes. The user selects which mode, phone or Internet, and the handset operates only in that mode. Thus, the call subsystem and Internet subsystem function independently as separate modes of operation for the wireless device. There has been no need to create a communication link between them to share device resources. Currently, a user in the phone mode is able to store phone numbers in phone books or speed dial directories. In Internet mode, the device stores domain names in a directory of “bookmarks” or “favorites.” Consider a business traveler user who stores the phone numbers and domain names of eight airlines, eight hotel chains, and four car rental agencies. A total of 40 entries are needed: 20 in the phone book and 20 in the bookmark directory of domain name favorites.

### SUMMARY OF THE INVENTION

A method of communication between a communication device user and a second entity occurs selectively across a telephone network and a computer network. A single communication device associates the second entity with a given numeric sequence as telephone number in the telephone network and associates the second entity with the given numeric sequence as an address in the computer network. A user of the device establishes establishing communication with the second entity selectively across the telephone network and the computer network.

The subject matter of the present invention is particularly pointed out and distinctly claimed in the concluding portion of this specification. However, both the organization and method of operation of the invention, together with further advantages and objects thereof, may best be understood by reference to the following description taken with the accompanying drawings wherein like reference characters refer to like elements.

### BRIEF DESCRIPTION OF THE DRAWINGS

For a better understanding of the invention, and to show how the same may be carried into effect, reference will now be made, by way of example, to the accompanying drawings in which:

FIG. 1 illustrates a process of providing Internet content by using telephone numbers as domain names.

FIG. 2 illustrates modification to communications enabled portable electronic devices to enable such devices to utilize phone numbers to access web resources.

FIG. 3 illustrates a wireless communication device operating according to the present invention.

FIG. 4 illustrates schematically by block diagram internal components of the communication device of FIG. 3 including a common directory shared between a telephone subsystem and browser subsystem thereof in selecting communication between voice and Internet channels for a given entry therein.

FIG. 5 illustrates operation of the device of FIGS. 3 and 4 including user selection of Internet or telephone communication for a given directory entry.

### DETAILED DESCRIPTION OF THE PREFERRED EMBODIMENT

According to one aspect of the present invention as set for the in applicants'first-filed and related provisional application, a process of providing Internet content uses telephone numbers as domain names. Registering phone numbers as domain names with ICANN's Shared Registration System (SRS) provides access to web content directly by way of the familiar telephone number format. Such registrations could include, but need not need be limited to, seven digit numbers, a seven digit number with an area code, and a “1” with area code plus a seven digit number. Registrations could utilize any top-level domain as an extension. Examples would include but need not be limited to: 3445026.com, 344-5026.com, 12083445026.org, 1-208-344-5026.org, 2083445026.net, or 208-344-5026.net. Use would include, but need not be limited to, the process of converting telephone calls to online sessions, or complimenting telephone calls with online sessions, by using the phone number dialed as the domain name to accesses an online solution; the use of telephone numbers stored in electronic devices to access web content or resources; and the process of displaying the resultant domain name in media, phone books, or other public venue.

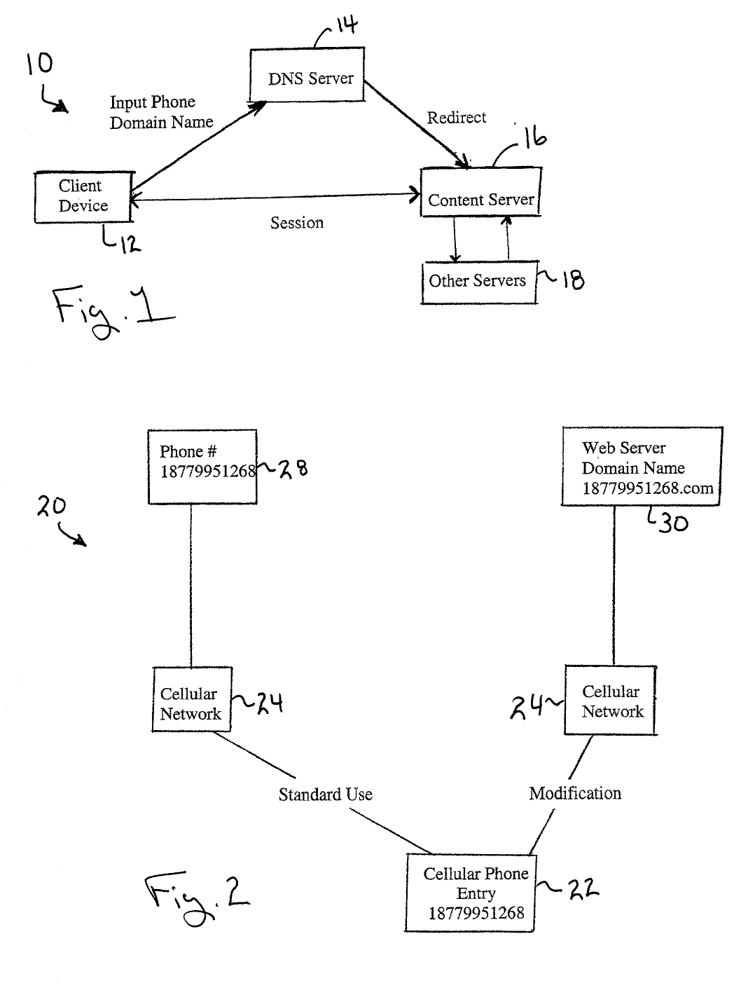

In FIG. 1, a communication system 10 includes a client device 12, a DNS server 14, a content server 16, and other servers 18. A user operating client device 12 inputs a phone domain name and transmits the phone domain name to the DNS server 14. DNS server 14 in turn identifies content server 16 as being associated with the phone domain name originating from the client device 12. DNS server 14 thereby redirects a connection with client device 12 to establish a session, i.e., a connection, between client device 12 and content server 16. In this manner, the user of client device 12 applies the familiar and well-known telephone number format as a domain name and reaches an associated content server, i.e., content server 16. As may be appreciated, the business entity associated with content server 16 also employs the same numeric sequence embodied in the phone domain name applied at device 12 as a telephone number.

Thus, a business entity associated with content server 16 has previously registered this phone domain name and enjoys two channels of access. More particularly, the business entity associated with content server 16 can be accessed by way of voice telephone channel of access by dialing a given numeric sequence and may be accessed by way of an Internet channel of access by entering the same numeric sequence as a phone domain name. Important to note, the phone domain name operates as a domain name and no additional structure or indirect connection need be established within the Internet for the content server 16 business entity to enjoy access by way of phone or Internet with the same numeric, i.e., phone domain name, sequence.

As may be appreciated, additional or other servers 18 may be coupled to content server 16 and enjoy also access by way of the same phone domain name associated with content server 16.

According to a second aspect of the present invention as set forth in applicants'second-filed and related provisional application, modifications to communications enabled portable electronic devices allow such devices to utilize phone numbers to access Web resources or send e-mail. Communication enabled electronic devices, such as cell phones or PDAs, thereby use phone numbers, stored in memory or directly input, to access domain names that are themselves telephone numbers plus a top-level domain as an extension thereof such as “.com”, “.gov”, or “.org”. An example would be the phone number 18779951268 being used to reach the resources of the domain name 1877995 1268.com. These domains would include seven digit local numbers, 10 digit long distance numbers, 1+10 digit long distance numbers, and international dialing conventions.

In a cellular phone, for example, this functionality is built into the device such that once a phone number is selected, rather than activating the voice function by pressing the Send or Talk button, Web resources are accessed by pressing a button or series of buttons. This action launches a web browser or e-mail program, which then utilizes the communications capability of the device to access and deliver Internet content. The buttons can be physical or electronic. The communications connections can be cellular, radio, or microwave. Connections can also be light such as infrared.

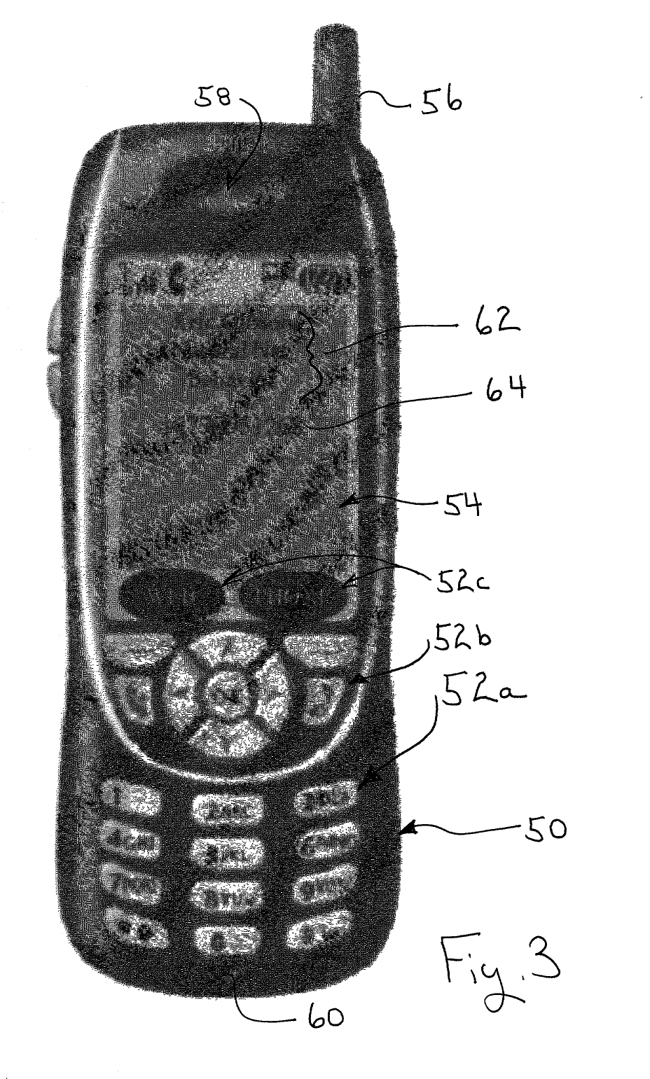

FIG. 2 illustrates standard and modified use of a mobile communication device, e.g., a wireless or cellular phone 22. In FIG. 2, a user enters a numeric sequence “18779951268” into the cellular phone 22 by way of a numeric keypad thereof. Given this base address, i.e., the numeric sequence “18779951268”, the user selects alternative channels of communication with alternate resources associated with this base address. More particularly, a standard use of phone 22 employs the base address “18779951268” to connect to a cellular network 24 which, in turn, connects to a remote phone 28, i.e., a phone associated with telephone number “18779951268.” In this manner, the cellular phone 22 operates in conventional fashion to access the cellular network 24 and establish a telephone, i.e., voice, network connection with phone 28. In the alternative, however, the user makes modified use of cellular phone 22 by connecting through cellular network 24 to a web server 30. More particularly, web server 30 has a registered domain name including the base address “18779951268” coupled to a top-level domain extension, in this case “.com.” Thus, the base address “18779951268” exists in the telephone line numbering standard and in the DNS registered domain name system. The user of cellular phone 22 creates one entry, i.e., the base address “18779951268”, and once entered or selected makes a decision as to voice communication on the telephone network or data communication on the Internet. In each case, to a business entity associated with telephone number “18779951268” or the web server 30 having a registered domain name of “18779951268.com.” Thus, cellular phone 22 has an electronic directory stored therein and a single directory entry is available to access a given business entity alternatively via the telephone network for a voice communication or via the Internet to establish a data communication.

Generally, the present invention relates to methods and modifications to communications enabled wireless communications devices that allow phone numbers, directly input or stored in phone books/speed dial or other directories for use in the call subsystem, to be used to access the Internet content represented by domain names that are that phone number plus a domain extension such as .com. The present invention also allows domain names that are phone numbers plus a domain extension, directly input or stored in a directory of “favorites” for use in the Internet subsystem, to be used by the phone subsystem to place a telephone call. An example is the phone book entry “12083445026” being converted to a domain name “12083445026.com.” This conversion takes place within the device itself and is not accomplished remotely.

The device directory may include information beyond the telephone number. Other entries may include name, address, company name, post office box, or other information deemed useful. The invention supports growth and evolution in the Internet, domain names, and Domain Name System (DNS). An example would be the elimination of top-level domain extensions or a movement to something other than Hypertext Transport Protocol (HTTP). Another example would be the supplanting of the DNS with an alternate name-to-address mapping system.

In one example of the present invention, a user with a web-enabled wireless phone accesses the phone book of the call subsystem, where phone numbers are stored, and selects a phone number. This is usually accomplished by selecting an alpha designator, such as a person's or company's name, representing that person's or company's phone number. In fact, a user may never see the phone number on the display, only the associated name. Numbers often may be displayed, however, by selecting a menu option such as “details.”

FIG. 3 illustrates an embodiment of the present invention, a web-enabled wireless communication device 50. As illustrated in FIG. 3, device 50 is a wireless cellular telephone modified relative to conventional operation for use according to the present invention. Device 50 may assume, in accordance with the present invention, a variety of form factors and communication protocols such as hand held PDAs, personal organizers, and the like.

In FIG. 3, device 50 corresponds generally to a “web enabled” cellular telephone including a set of user-activated keys 52. More particularly, a set of alphanumeric keys 52a, a set of navigation keys 52b, and, as provided under the present invention, a set of communication channel selection keys 52c. Device 50 also includes a display 54, an antenna 56, an earpiece 58, and a microphone 60. As may be appreciated, device 50 operates generally in the fashion of a cellular telephone as enabled for web access.

In accordance with the present invention, however, device 50 provides to the user thereof a more convenient and efficient mechanism for selecting between and for switching back and forth between voice communication and data communication such as on the Internet. More particularly, device 50 allows a user thereof access to a stored directory including a plurality of entries therein. As shown in FIG. 3, one such directory entry is presented at display 54 of device 50. This entry includes identifying information or name designator 62 and, in accordance with the present invention, a base address designator 64 comprising, in the illustrated example, a sequence of numerals “18779951268.” In accordance with the present invention, the entity “Natural Net Behavior” as indicated by entity name designator 62 is associated with the base address designator 64 both as a telephone number and as a registered domain name.

Once the user of device 50 brings to display 54 and entry including an entity name designator 62 and base address designator 64, the user has the option of selecting communication with the entity in designator 62 by voice communication or Internet communication. More particularly, selection keys 52c include a “WEB” key and a “PHONE” key. Pressing the “WEB” key initiates within device 50 an Internet session with the business entity as indicated in designator 62 at the domain name as indicated at base address 64. As will be described more fully hereafter, a top-level domain name is appended to the base address designator to form a complete domain name. By pressing the phone key, however, device 50 initiates a telephone call to the telephone number as indicated in base address designator 64. Thus, from a single directory entry held by device 50 the user of device 50 has the option of selecting a data communication channel or a voice communication channel.

Traditionally, wireless phone use is limited to pressing a “Talk ” or “Send” key to launch a phone call. This use remains available under the present invention. The enhancement provided under the present invention takes this same selected entry from the device 50 phone book and, by pressing the “WEB” key launches an Internet session accessing the resources of the domain name which is identical to or associated with that phone number as converted to a domain name with a top-level domain extension such as “.com” and registered with, and supported by, the Domain Name System. This translation from a phone number to a domain name may be accomplished by the device 50 phone subsystem, the device 50 browser, or some intermediary module of device 50.

Conversion from base address designator 64 to an appropriate domain name can be accomplished within device 50 under the “browser” programming thereof. Upon selecting the “WEB” key, device 50 launches the browser in the Internet subsystem. Once active, the phone subsystem of device 50 passes designator 64 to the browser programming. If required, the designator 64 is translated to a data format used by the browser. In this example, the browser would pre-pend “http://www” denoting Hypertext Transfer Protocol (HTTP) and the World Wide Web (WWW). At this point, the browser launches a web search. Most browsers will assume, if not specified, that “.com” is the top-level domain extension. If not found, i.e., if not found by the DNS server upon request therefor, browsers will progress through other top-level domain extensions until a domain name is located by the DNS server. If the domain name is not located, an error message is returned. This feature of conventional browsers, taking a domain name and appending necessary text to form a complete Universal Resource Locator (URL), is a well known convention and used under the present invention.

It is possible that an existing top-level domain may become standard for phone number based domain names. In such case, such existing top-level domain extension would be automatically appended to the base address designator 64. It is also possible that a new top-level domain could be created to support these domain names. If this occurs, the browser would append the appropriate domain extension. The present invention can be adapted to support a variety of Protocols or evolutionary developments of the Internet.

The preferred format is the “WEB” key on device 50 whereby, once the directory entry is selected, only one key stroke is required to launch a web session. It is also possible to use a series of key strokes, but the more key strokes required the less likely a user is to make use of this feature. Keys potentially may be soft keys or touch screen keys. It would also be possible to support this activity in voice command devices using voice commands such as “Select, Hilton, Phone” or “Select, Hilton, Web”.

The present invention supports a new domain name standard. Users have been taught away from number-based domain names. Even the descriptor “domain name” sets an expectation of a text-based form. Domain names are thought to be necessarily intuitive so that they may be remembered. But with portable memory to store the name for the user, remembering it is not important.

A major advantage of support for phone number based domain names is that there is no need for critical mass for success, i.e., it need not be implemented on a large scale to justify implementation. By taking advantage of the existing Domain Name System, the cost for use of a phone number based domain name is minimal. There is no product testing and development required. The functionality is instantaneous and understanding the form is familiar and simple. People understand and work easily with phone numbers. It could be manifest as simply as “3445026.com” painted on the side of a landscape truck. Or, it could be as complex as every supported telephone number being displayed in the phonebook white pages with the appropriate top-level domain extension. If a user has an existing alpha based domain name it can be used in concert with the numerically-based telephone number domain name as proposed under the present invention.

In an example where a traveling user wishes to store the phone numbers and domain names of eight airlines, eight hotel chains, and four car rental agencies 40 entries are needed. 20 in the phone book and 20 in the directory of favorites. With the present invention, only 20 directory entries are needed. This saves time and device memory relative to a device storing in separate directories phone numbers and domain names.

In another example, a user experiencing a power outage calls their power company. During a power outage, it may be impossible to reach the power company because the line is busy. In this scenario, the user simply presses the “WEB” button and the device links to the phone number based domain name. At the power company's web site addressed by the phone number-based domain name, the user accesses information about the power outage.

In another example, a user checking airline flight availability on the web decides they need to speak to a representative. By pressing the “call” button the phone number based domain name transfers to the call subsystem to initiate within device 50 a phone call to the representative.

Another useful feature supported by the present invention is the use of the names identifying phone numbers in the phone book as domain names. These could similarly be handed off to the browser for use as a domain name. In this way, an alpha/alpha numeric domain name could be supported with the advantage of not having to create entries in both a phone book directory and a favorites directory. An example would be the use of the alpha identifier in the phone book “Hilton” to be handed off to the Internet subsystem to reach the resources of “Hilton.com” as discussed more fully hereafter.

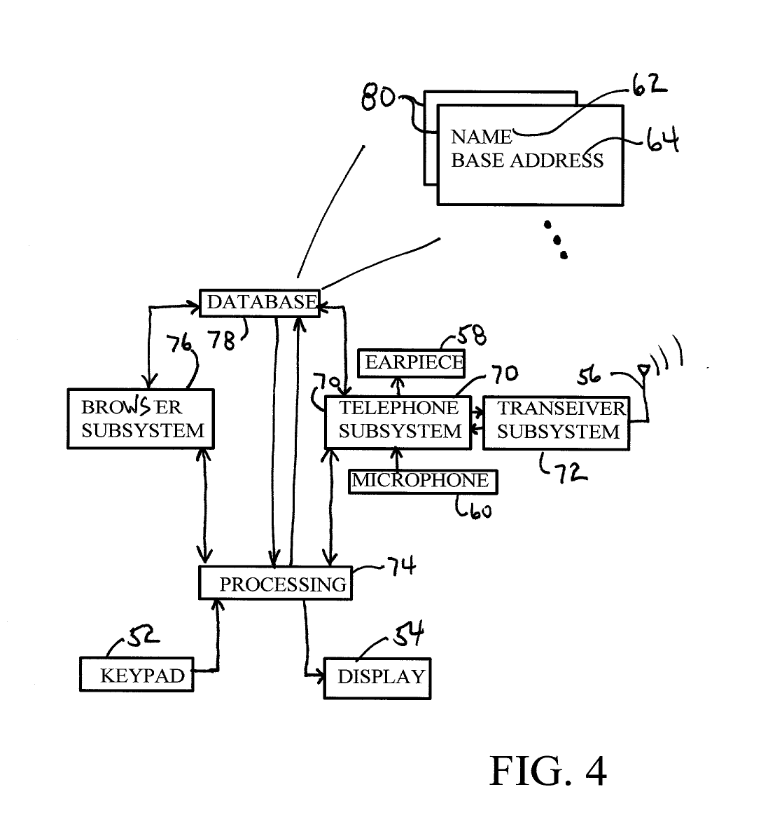

FIG. 4 illustrates schematically by block diagram the internal components of device 50. In FIG. 4, device 50 includes keypad 52, display 54, antenna 56, earpiece 58, and microphone 60 as indicated in FIG. 3. Earpiece 58 and microphone 60 couple to a telephone subsystem 70 in convention al fashion. Antenna 56 couples to a transceiver subsystem 72. As may be appreciated, telephone subsystem 70 couples to transceiver subsystem 72 to activate and conduct traditional cellular telephone communications. A processing block 74 couples to keypad 52 and display 54 and executes appropriate programming as described herein receiving user input and presenting suitable displays to support operation as described herein. Processing block 74 interacts with telephone subsystem 70 to direct operation thereof. A browser subsystem 76 supports Internet activity and also couples to processing block 74. In accordance with the present invention, a database block 78 stores a series of directory entries 80 therein. Each directory entry 80 includes a name designator 62 and a base address designator 64. As may be appreciated, each entry 80 may include a variety of other information fields. Also, database 78 would include a plurality of entries 80 limited in number by the memory resource capacities of block 78.

Thus, device 50 includes a at least one database or directory as maintained in block 78 wherein each entry 80 thereof includes in association a name designator 62 and a base address designator 64. Processing block 74 interacts with a user by way of keypad 52. A user of device 50 has an ability, therefore, to bring to display 54 one of entries 80 taken from database 78. Once displayed, entry 80 provides to the user of device 50 an opportunity to select communication with the entity associated with designator 62 either by way of Internet or voice communication. More particularly, by operation of keys 52c, i.e., selecting the “WEB” key or the “PHONE” key thereof, the user of device 50 initiates activation of the browser subsystem 76 or the telephone subsystem 70, respectively. In either case, device 50 makes use of the base address designator 64 in making contact with the entity associated with name designator 62. More particularly, the telephone subsystem uses directly the base address designator 64 as a telephone number and initiates a telephone call by way of transceiver subsystem 72. Browser subsystem 76, however, must append certain information to base address designator 64 in order to complete an appropriate domain name, i.e., must add to the beginning of base address designator 64 text such as “http:/www.” and must append to the end appropriate top-level domain name text.

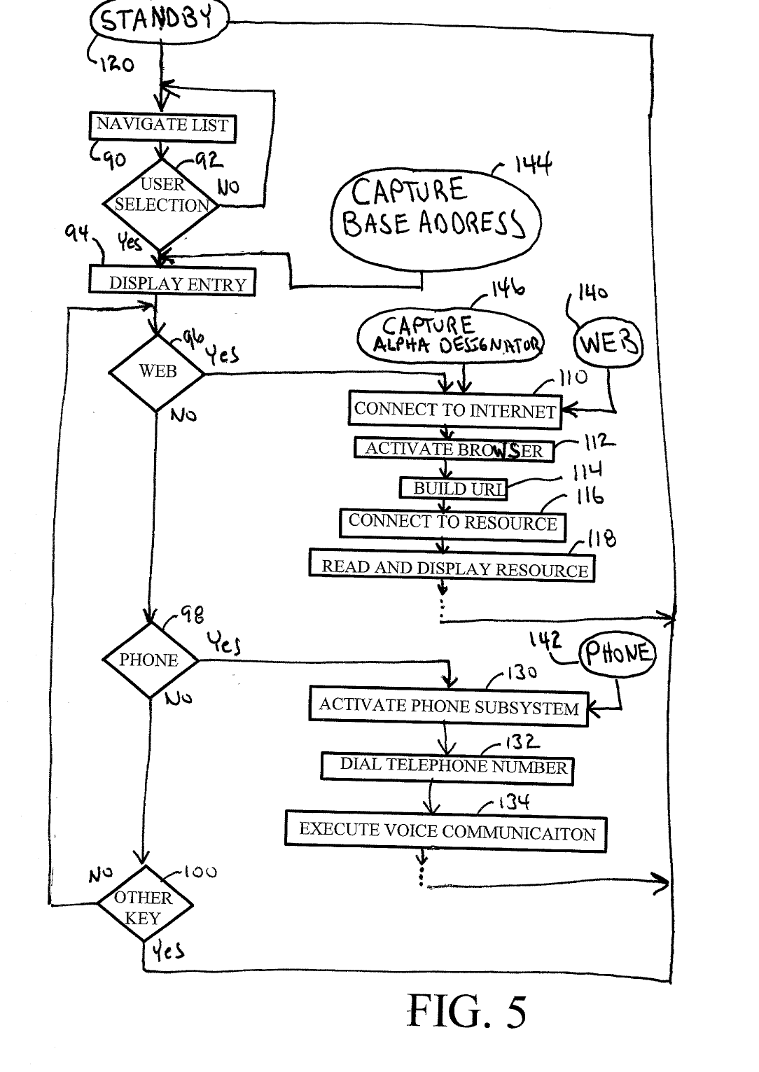

FIG. 5 illustrates user operation of device 50 in selecting an entry 80 previously stored in device 50 and choosing communication with the associated entity either by Internet or voice communication. In FIG. 5, block 90 represents user navigation of database 78 including use of navigation keys 52b (FIG. 3) to bring to display 54 a selected one of entries 80. Such navigation may be done serially or by lookup mechanism as is conventionally done in existing cellular telephones. Device 50 presents on display 54 entries 80 and in decision block 92 provides an opportunity for user selection thereof. If the user declines selection, processing returns to block 90. If the user selects for communication the entry 80 presently shown on display 54, processing advances to block 94 where device 50 displays the selected entry 80 for contact. Device 50 then queries, i.e., checks user activation of, keys 52c to determine a selected channel of communication. More particularly, in decision block 96 device 50 determines whether the “WEB” key has been pressed. If the “WEB” key has not been pressed, then, in decision block 98, device 50 determines whether the “PHONE” key has been pressed. If the “PHONE” key has not been pressed then in decision block 100 device 50 determines whether any other key has been pressed, i.e., indicating that the user does not wish to communicate with the entity currently indicated on display 54. In such case, processing then returns to the navigation opportunities of block 90. Otherwise, processing loops through decision blocks 96, 98, and 100 until the user of device 50 selects either the “WEB” key, the “PHONE” key, or some other key indicating a desire to abort selection of the current entry 80. Thus, device 50 allows a user thereof opportunity to select from a single database an entry thereof and thereafter determine by one keystroke a channel of contact therewith, i.e., contact by way of Internet or telephone communication.

If the user selects the “WEB” key and processing branches at block 96, device 50 executes block 110 programming including an appropriate connection to an Internet Service Provider (ISP). In block 112, device 50 activates browser subsystem 76 in anticipation of Internet communication. Continuing to block 114, device 50 builds an appropriate universal resource locator (URL) as a function of the base address designator 64 of the currently selected entry 80. As previously discussed herein, building a URL may consist of automatically pre-pending to base address designator 64 text such as “http:/www.” and appending to base designator 64 a top-level domain name extension. The top-level domain name extension may be initially assumed to be “.com”, but if such URL is invalid, i.e., no connection is made, other top-level domain name extensions may be selected and used until an appropriate URL is found, i.e., one which results in a connection to an Internet resource. Alternatively, database 78 may include in each entry 80 an additional field indicating the appropriate top-level domain name extension required in order to contact the entity associated with name designator 62.

Once an appropriate URL is constructed and connection to an Internet resource is established in block 116, device 50 supports reading and displaying of the Internet resource and content in block 118 according to conventional Internet browsing methods. More particularly, the user is provided opportunity to navigate by use of navigation keys 52b the Internet resource and, if desired, link to other Internet resources in conventional fashion as is well known according to HTTP protocol. Eventually, the user terminates the Internet session and device 50 returns to a standby mode 120 in anticipation of a next user navigation event, i.e., user selection of an entry 80 from database 78.

If the user selects in decision block 98 telephone communication with the entity associated with name designator 62 as selected in decision block 92, processing branches to block 130 where device 50 activates the telephone subsystem 70 and employs base address designator 64 directly as a telephone number to communicate by voice connection in conventional cellular telephone fashion. Thus, in block 132 device 50 dials as a telephone number the base address designator 64 and supports voice communication in block 34 according to conventional cellular telephone processing. Eventually, the user terminates the telephone connection and device 50 returns to standby mode 120 ready for a next user navigation event in block 90 and subsequently database 78 directory entry 80 selection in block 92.

Device 50 switches at user request between an Internet connection, e.g. processing in blocks 110-118, and a telephone connection, e.g., processing in blocks 130-134. More particularly, device 50 possesses a currently selected base address 64 following execution of decision block 92. In effect, the user has identified an entity for communication and can by use of selection buttons 52c switch from a telephone connection with that entity to an Internet connection with that entity, or switch from an Internet connection with that entity to a telephone connection with that entity. Thus, interrupt processing in block 140 executes in response to user-activation of the “WEB” key of selection keys 52c, e.g. during a telephone connection, and directs processing to block 110 where an Internet connect is established with the entity associated with the currently selected base address 64. Similarly, interrupt processing in block 142 executes in response to user-activation of the “PHONE” key of selection keys 52c, e.g. during an Internet session, and directs processing to block 130 where a telephone connection is established with the entity associated with the currently selected base address 64.

Additional interrupt processing in block 144 allows the user to capture a new base address 64 as a currently selected base address 64 by a variety of mechanisms other than those base addresses 64 previously stored in data base 78. For example, when a user enters manually a sequence of number at keys 52a, e.g., as seen in an advertisement or as taken from a telephone book or other source, the user of device 50 activates interrupt programming 144 and selects such sequence as the currently selected base address 64. When an incoming call presents a caller ID as a numeric sequence, the user can activate interrupt programming block 144 and select the incoming phone number as a currently selected base address 64. Another opportunity to capture and select a new base address 64 is during an Internet session where the user of device 50 selects text thereform representing a phone number. Consider a textual display presented during an Internet session, not a hyper-link but rather a phone number presented as text. The user of device 50 highlights and selects such numeric sequence as a currently selected base address 64 by activation of, i.e., appropriate keypad 52 operation initiating, interrupt programming 144.

Processing then branches to block 94 for display and then to decision block 96 where the user has the option of making a telephone connection or an Internet connection using that numeric sequence as a telephone number or as a telephone number domain name. Business entities having registered their phone numbers as phone number domain names enjoy the benefit of user-selected channels of communication, i.e., users can select telephone or Internet communication with the business entity.

Consider a sales call presenting a caller ID phone number also registered as telephone number domain name. The recipient of the phone call selects the caller ID numeric sequence as a currently selected base address 64 and, as more fully discussed below, switches during the sales call to Internet resources associated with the sales call.

Consider a telephone conversation with a representative of a given business entity. During the conversation, device 50 possesses as a currently selected base address 64 a numeric sequence corresponding to the telephone number for that business entity. The currently selected base address 64 could be taken from data base 78 as described above, or be taken from a user-dialed numeric sequence used to initiate the telephone conversation or from a caller ID value captured when the call was received by the user. In any case, device 50 possesses a numeric sequence, i.e., phone number, corresponding the business entity at the other end of the telephone connection.

As is frequently the case, the telephone conversation includes reference to resources of the business entity available on the Internet, e.g., the user can obtain information concerning the business entity from an Internet site provided by the business entity. Under the present invention, the business entity links such information to a domain name and URL corresponding to the phone number, i.e., a phone number domain name as described herein. The user simply presses the “WEB” button on device 50 and device 50 connects to the Internet and presents the resources referenced in the telephone conversation.

Important to note, device 50 sends the user directly to the specific resources discussed in the telephone conversation. As is typical, many Internet users are simply sent to the main page of a given business entity and must thereafter navigate through the Internet site to find information referenced in the telephone conversation. Under the present invention, however, the business entity associates Internet resources, i.e., information, with a telephone number domain name and URL and invites telephone interaction relative to such resources on the corresponding telephone number.

This method is particularly useful for tracking the success of a given marketing campaign. By conducting advertising in association with a particular phone number and corresponding registered phone number domain name, the business entity can track user response directly by tracking use of that telephone number and telephone number domain name. Furthermore, by tying together the telephone number and telephone number domain name as described herein, the user can switch back and forth between telephone conversations with a business entity representative and Internet sessions with a specific Internet resource within an overall Internet site provided by the business entity.

Thus, by pressing a single button on device 50 the user switches between channels of communication with a given entity. Business entities having registered telephone domain names corresponding to actual telephone numbers where voice communication can occur capitalize on dual channels of communication with customers or potential customers, better track marketing activities associated with particular telephone numbers and telephone number domain names, and better manage customer contacts by allowing the users of device 50 to switch seamlessly between Internet and telephone conversations relative to a given business entity or particular products or services of a given business entity.

Interrupt programming block 146 in FIG. 5 represents an opportunity for the user of device 50 to attempt an Internet connect with an entity in data base 78 having an alpha designator, i.e., name field 62. More particularly, upon activation of interrupt programming 146, device 50 takes as a base domain name the alpha designation or entity name field 62 as found in a selected entry 80 and teats it similarly to a base address 64. In other words, device 50 connects to the Internet and builds a URL based on the field 62. Many business entities have, and all desire to have, a domain name corresponding directly to the business entity name. For example, the business entity known a “Hilton” has a URL at the domain name “Hilton.com.” Given an entry 80 in data base 78 having a field 62 holding the text string “Hilton”, device 50, in response to interrupt programming 146, attempts to contact by Internet session the site “Hilton.com” through programming of blocks 110-118. As may be appreciated, programming in block 114 attempts to build a valid URL and will, as previously described, attempt to append various top-level domain extensions to create an appropriate URL.

The present invention recognizes that a unique number string suitable as a domain name is the familiar dialing pattern of the traditional phone number. Most organizations have a well-established phone number registrable as a domain name. Once registered and linked to an IP address, a telephone number domain name offers all of the functionality of any text-based domain name. It has the added benefit of being easy to dial on small numeric keypads such as those on cell phones.

The present invention applies also to Email network communications as an alternative to accessing an Internet site using the base address designator 64 and appending a top-level domain name thereto. The present invention contemplates use of the base address designator 64 as a basis for building an Email address corresponding to a registered telephone number domain name and top-level extension and appropriate additional routing text to establish a network communication.

It will be appreciated that the present invention is not restricted to the particular embodiment that has been described and illustrated, and that variations may be made therein without departing from the scope of the invention as found in the appended claims and equivalents thereof.

What is claimed is:

1. A method of communication between a first entity and a second entity selectively across a telephone network and a computer network, the method comprising:
associating said second entity with a given numeric sequence as telephone number in said telephone network;
associating said second entity with said given numeric sequence as an address in said computer network; and
establishing communication between said first entity and said second entity selectively across said telephone network and said computer network in response to said first entity designating said given numeric sequence.

2. A method according to claim 1 wherein said establishing step is accomplished by a single communication device having access to a base address designator comprising said numeric sequence.

3. A method according to claim 2 wherein said base address designator is stored in said communication device in association with said second entity and said first entity is a user of said device.

4. A method according to claim 2 wherein said communication device is a mobile wireless communication device.

5. A communication device comprising:
a telephone voice communication capability;
a network communication capability;
user designation of a numeric sequence; and
user selection of a network communication using said network communication capability and said numeric sequence and of a voice communication using said voice communication capability and said numeric sequence.

6. A communication device according to claim 5 wherein said communication device comprises a keypad and said user selection comprises user activation of said keypad by one of a first keypad operation initiating said network communication and a second keypad operation initiating said voice communication.

7. A communication device according to claim 6 wherein said first key operation comprises user activation of a single key of said keypad.

8. A communication device according to claim 6 wherein said second key operation comprises user activation of a single key of said keypad.

9. A communication device according to claim 5 wherein said device initiates said voice communication during said network communication.

10. A communication device according to claim 5 wherein said device initiates said network communication during said voice communication.

11. A communication device according to claim 5 wherein said user designation of said numeric sequence comprises storing said numeric sequence in a memory portion of said device.

12. A communication device according to claim 5 wherein said user designation of said numeric sequence comprises entering manually said numeric sequence by way of a keypad of said device.

13. A communication device according to claim 5 wherein said device appends to said numeric sequence a top-level domain text sequence as addressing in establishing said network communication.

14. A communication device according to claim 5 wherein said device attempts to establish a network communication using an alpha-numeric designator stored in said communication device in association with said numeric sequence.

15. A wireless communication device comprising:
a user-operated keypad;
a display;
a telephone voice communication capability;
a network communication capability;
user designation of a numeric sequence in association with an alpha-numeric name designator; and
user selected activation of a network communication using said network communication capability and said numeric sequence and of a voice communication using said voice communication capability and said numeric sequence, said network communication being initiated in response to user activation of a first key of said keypad, said voice communication being initiated in response to user activation of a second key of said keypad.

16. A communication device according to claim 15 wherein said device initiates said voice communication during said network communication.

17. A communication device according to claim 15 wherein said device initiates said network communication during said voice communication.

18. A communication device according to claim 15 wherein said user designation of said numeric sequence comprises storing said numeric sequence in a memory portion of said device.

19. A communication device according to claim 15 wherein said user designation of said numeric sequence comprises entering manually said numeric sequence by way of said keypad of said device.

20. A communication device according to claim 15 wherein said device appends to said numeric sequence a top-level domain text sequence as addressing in establishing said network communication.
